(19) United States
(12) Patent Application Publication
(10) Pub. No.: US 2021/0286544 A1
(43) Pub. Date: Sep. 16, 2021

(54) ECONOMIC LONG SHORT-TERM MEMORY FOR RECURRENT NEURAL NETWORKS

(71) Applicant: University of Louisiana at Lafayette, Lafayette, LA (US)

(72) Inventors: Kasem Khalil, Lafayette, LA (US); Omar Eldash, Lafayette, LA (US); Ashok Kumar, Lafayette, LA (US); Magdy Bayoumi, Lafayette, LA (US)

(21) Appl. No.: 17/197,401

(22) Filed: Mar. 10, 2021

Related U.S. Application Data
(60) Provisional application No. 62/987,487, filed on Mar. 10, 2020.

(51) Int. Cl. G06F 3/06; G06N 3/02; G06F 7/523; G06F 7/50

(52) U.S. Cl. CPC G06F 3/0652; G06N 3/02; G06F 3/0604; G06F 7/50; G06F 3/0673; G06F 7/523

(57) ABSTRACT

Disclosed herein is a novel approach to Long Short-Term Memory (LSTM) that uses fewer units for processing than other LSTM systems currently available. This LSTM system has the ability to retain memory and learn data sequences using one gate. The benefit of the disclosed system is performing the learning process at a faster speed to the lower number computation units.

### CROSS REFERENCE TO RELATED APPLICATIONS

This application claims priority to U.S. Provisional Application No. 62/987,487 titled ECONOMIC LONG SHORT-TERM MEMORY FOR RECURRENT NEURAL NETWORKS, filed on Mar. 10, 2020.

### STATEMENT REGARDING FEDERALLY SPONSORED RESEARCH OR DEVELOPMENT

Not applicable.

### REFERENCE TO A “SEQUENCE LISTING”, A TABLE, OR COMPUTER PROGRAM

Not applicable.

### DESCRIPTION OF THE DRAWINGS

The drawings constitute a part of this specification and include exemplary examples of the ECONOMIC LONG SHORT-TERM MEMORY FOR RECURRENT NEURAL NETWORKS, which may take the form of multiple embodiments. It is to be understood that in some instances, various aspects of the invention may be shown exaggerated or enlarged to facilitate an understanding of the invention. Therefore, drawings may not be to scale.

FIG. 1 provides a block diagram of the disclosed Economic Long Short-Term Memory (ELSTM) solution in weight update flow.

FIG. 2 provides the structural conceptual details of arithmetic, weights, and biases of the ELSTM.

FIG. 3 provides a table comparing the results of the ELSTM to LSTM systems currently known in the art.

FIG. 4 provides the results of an accuracy simulation of the ELSTM using the MNIST dataset.

FIG. 5 provides the results of an accuracy simulation of the ELSTM using the IMBD dataset.

FIG. 6 provides the results of an accuracy simulation of the ELSTM using the ImageNet dataset.

FIG. 7 provides an accuracy comparison of the ELSTM to known LSTM structures using multiple datasets.

FIG. 8 provides a table comparing the error rate of ELSTM to known LSTM structures.

FIG. 9 provides a block diagram of the hardware gate module.

FIG. 10 provides the hardware module for the ELSTM final stage.

FIG. 11 provides a table of the hardware implementation results.

### FIELD OF THE INVENTION

The field of the invention is recurrent neural networks, specifically long short-term memory and hardware architecture for recurrent neural networks.

### BACKGROUND OF THE INVENTION

Machine learning is a form of artificial intelligence that can be used to automate decision making and predictions. It can be used for image classification, pattern recognition (e.g., character recognition, face recognition, etc.), object detection, time series prediction, natural language processing, and speech recognition. Three structures of Machine Learning known in the art are Convolutional Neural Networks (CNN), Feed-Forward Deep Networks (FFDN) and Recurrent Neural Networks. See A. Karpathy, G. Toderici, S. Shetty, T. Leung, R. Sukthankar, and L. Fei-Fei, “Large-scale video classification with convolutional neural networks,” in Proceedings of the IEEE conference on Computer Vision and Pattern Recognition, 2014, 1725-1732; X. Glorot and Y. Bengio, “Understanding the difficulty of training deep feedforward neural networks,” in Proceedings of the IEEE conference on Computer Vision and Pattern Recognition, 2010, 249-256; D. P. Mandic and J. Chambers, Recurrent neural networks for prediction: learning algorithms, architectures, and stability, John Wiley & Sons, Inc., 2001.

RNN has been applied to speech recognition, language translation, image captioning, and action recognition in videos. RNN is a deep model when it is unrolled along the time axis. One main advantage of RNN is that RNN can learn from previous data and information. The key point is what to remember and how far a model remembers. In a standard RNN, recent past information is used for learning. The downside is that RNN cannot learn long-term expectations or dependencies due to vanishing or exploding gradients. To overcome this deficiency, Long Short-Term Memory (LSTM) has been proposed in the art. LSTM is an architecture of RNN where memory controllers are added for deciding when to forget, remember, and for output. Addition of LSTM allows expansion of the training procedure to learn long-term dependencies.

Hao Xue et al. previously presented a hierarchal LSTM Model to consider both the scene layouts and influence of social neighborhood to predict pedestrians' future trajectory. H Xue, D. Q. Huynh, and M. Reynolds, “SS-LSTM: a hierarchal lstm model for pedestrian trajectory prediction,” in 2018 IEEE Winter Conference on Applications of Computer Vision (WACV), IEEE (2018), 1186-1194. In their approach, known as Social-Scene-LSTM (SS-LSTM), three different LSTMs are used to capture social, personal, and scene scale information. A circular shaped neighborhood is used instead of a rectangular shape. The SS-LSTM approach was tested using three datasets, and the simulations results show the prediction accuracy is improved due to using a circular shape neighborhood.

For a hardware implementation, RNN hardware design is not all done on neural networks. For example, Chang et al. presented a hardware implementation of RNN on FPGA. A. X. M. Chang, B. Martini, and E. Culurciello, “Recurrent neural networks hardware implementation on FPGA”, arXiv preprint arXiv: 1511.05552, 2015. This hardware implementation was done on the programmable logic Zynq 7020 FPGA from Xilinx for LSTM. The implementation has two layers with 128 hidden units, which the method being tested using a character level language model. Performance per unit power of different embedded platforms could be studied.

A standard LSTM consists of three gates and two activation functions. The first step of LSTM is to decide which information should be forgotten from the cell state, which is known as the “forget gate.” The second step is to make a decision on what new information will be stored in the cell. This action is performed by the “input gate” which decides values to be updated and then creates new candidate values. Finally, the output layer decides the data that will go to output. The equation of each part is calculated as follows:

fₜ=σ(W_{f}[hₜ₋₁,xₜ]+b_{f})

iₜ=σ(Wᵢ[hₜ₋₁,xₜ]+bₜ)

oᵣ=σ(Wₒ[hₜ₋₁,xₜ]+bₒ)

\tilde{c}ₜ=tanh(W_{c}[hₜ₋₁,xₜ]+b_{c})

cₜ=fₜ⊙cₜ₋₁+iₜ⊙\tilde{c}ₜ

hₜ=oₜ⊙tanh(cₜ)

Where for the matrix multiplication W_{f} [hₜ₋₁,xₜ]=Wₕhₜ₋₁+Wₓxₜ, fₜ is the result of the forget gate, iₜ is the input gate result, and oₜ is the output gate result. The new state memory is \tilde{c}ₜ, the final state memory is cₜ, and the cell output is hₜ. The weights of the forget gate, input gate, and output gate are W_{f}, Wᵢ, and Wₒ, respectfully. The biases are b_{f}, bᵢ, and bₒ for the forget, input and output layer, respectfully. The symbol of ⊙ represents the elementwise (Hadamard) multiplication, σ is the logistical sigmoid function, and tanh is the hyperbolic tangent function.

LSTM has been proposed in the art with variations to make it simple and improve its performance. Greff et al. presented a coupled-gate LSTM, in which the forget gate and input gate are coupled into one. K. Greff, R. K. Srivastava, J. Koutnik, B. R. Steuebrink, and J. Schmidhuber, “LSTM: a search space odyssey”, IEEE transactions on neural networks and learning systems, vol. 28, no. 10 (2017), 2222-2232. Therefore, the structure has one gate less which makes it simpler than LSTM. The consequence is that the coupled-gate LSTM leads to reduced computational complexity and slightly higher accuracy. Cho et al. present another LSTM variation which is called the Gated Recurrent Unit (GRU) architecture. Instead of using three gates in LSTM, GRU includes two gates: update gate and rest gate. The update gate operation combines the forget gate and input gate while the rest gate has the same functionality as the output layer. GRU model simplified LSTM by eliminating the memory unit and the output activation function. K. Cho, B. Van Merrienboer, C. Gulcehre, D. Bandanau, F. Bougares, H. Schwenk, and Y. Bengio, “Learning phrase representations using rnn encoder-decoder for statistical machine translation,” arXiv preprint arXiv: 1406.1078 (2014). Zhou et al. simplified the LSTM by only using one gate, named as Minimal Gated Unit (MGU). MGU does not include the memory cell which is similar to GRU. G. B. Zhou, J. Wu, C. L. Ahang, and Z. H. Zhou, “Minimal gated unit for recurrent neural networks,” International Journal of Automation and Computing, vol. 13, no. 3 (2016), 226-234. GRU model has faster training, higher accuracy, and fewer trainable parameters compared to LSTM. Elsayed et al. present a reduced-gate convolutional LSTM (rgcLSTM) architecture which is another one-gate method. N. Elsayed, A. S. Maida, and M. Bayoumi, “Reduced-gate convolutional lstm using predictive coding for spatiotemporal prediction,” arXiv preprint arXiv: 1810.07251 (2018). It uses a memory cell, and it has a peephole connection from the cell state to the network gate.

### SUMMARY OF THE INVENTION

A novel LSTM structure is disclosed designed to reduce training parameter and increase training speed when retaining or increasing the performance. The results of all versions of LSTM show that models with fewer parameters may provide higher accuracy. Thus, the novel LSTM structure disclosed herein utilizes one gate and two activation functions. In contrast to known LSTM designs, the gate (a) comprises both the forget (update) gate and the input (reset) gate. The disclosed design's performance is comparable to previous LSTM designs.

### DETAILED DESCRIPTION OF THE INVENTION

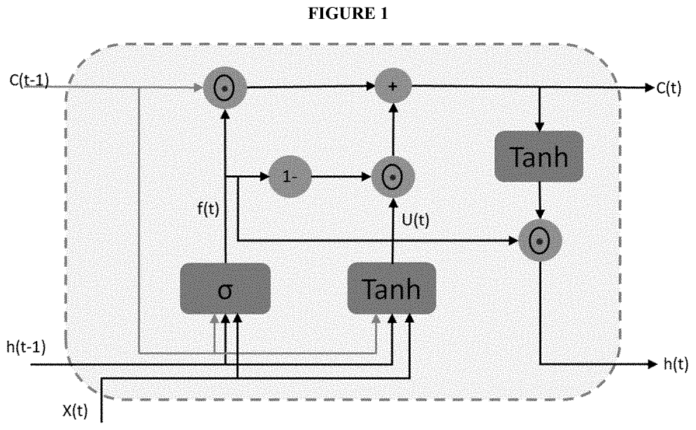

The disclosed Economic LSTM (ELSTM), shown in FIG. 1, provides a novel cell architecture of LSTM using one gate. In the disclosed cell architecture, the single gate (a) comprises functionality to delete and update data. The output of this gate (a) ultimately feeds three parts of the architecture: the memory layer, the update layer, and the output layer. In the memory layer, using the functions x(t), h(t−1), and c(t−1), the output provides values of this gate fₜ which is multiplied with the memory state for a forgetting step. The forget step fₜ is generated as an output of gate (σ), and then the elementwise product between 1−fₜ and the output of Tanh which is calculated by x(t), h(t−1), and cₜ₋₁ are both calculated. The memory state is used in the calculation to get accurate performance and stability in terms of forgetting and updating to improve the learning performance as compared to MGU.

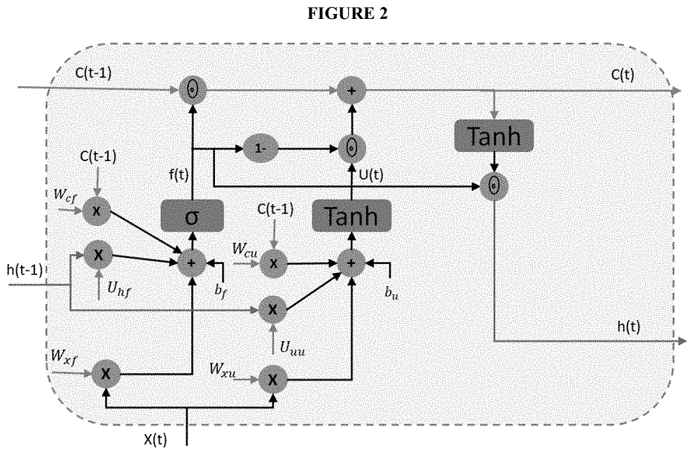

FIG. 2 shows the structural conceptual details of arithmetic, weights, and biases of the ELSTM. The output of the gate is given by:

f(t)=σ(W_{f}·I_{f}+b_{f})

f(t)=σ([W_{cf},W_{xf},U_{hf}]·[x(t),c(t−1),h(t−1)]+b_{f})

Where I_{f} is a general input in this case, a forget gate activation vector f(t)ϵR^{d×h×n} where d is the width, h is the height, and n is the number of channels of fₜ. Input vector x(t)ϵR^{×h×r} is the input which may be an image, audio, etc. and r is the number of input channels. h(t−1) comprises the output of the block or cell at the time of (t−1), the stack representing the internal state at the time of (t−1) is called c(t−1). The same as f(t), h(t−1), and c(t−1)ϵR^{d×h×n} For the weights, W_{xf}, W_{cf}, and U_{hf} are the convolutional weights, and they have dimension (m×m) for all the kernels, and b_{f} is the bias which has a dimension of n×1. The input update equation is obtained by:

u(t)=tanh(Wᵤ·Iᵤ+bᵤ)

u(t)=tanh([W_{cu},Wₓᵤ,Uᵤᵤ]·[x(t),c(t−1),h(t−1)]+bᵤ)

Where lᵤ is a general input, an update activation vector u(t)ϵR^{d×h×n}, and it matches the dimension of fₜ·bᵤϵR^{n×1} also matches the dimension of b_{f}ϵR^{n×1}. The output of Uₜ of tanh is multiplied by 1−fₜ, the multiplication result will be added with the memory state to generate the updated memory state. The new state is used to produce the desired output using tanh and the output gate fₜ. The equations of the memory state and the output are finalized by the following equations:

C(t)=f(t)⊙C(t−1)+(1−f(t))⊙U(t)

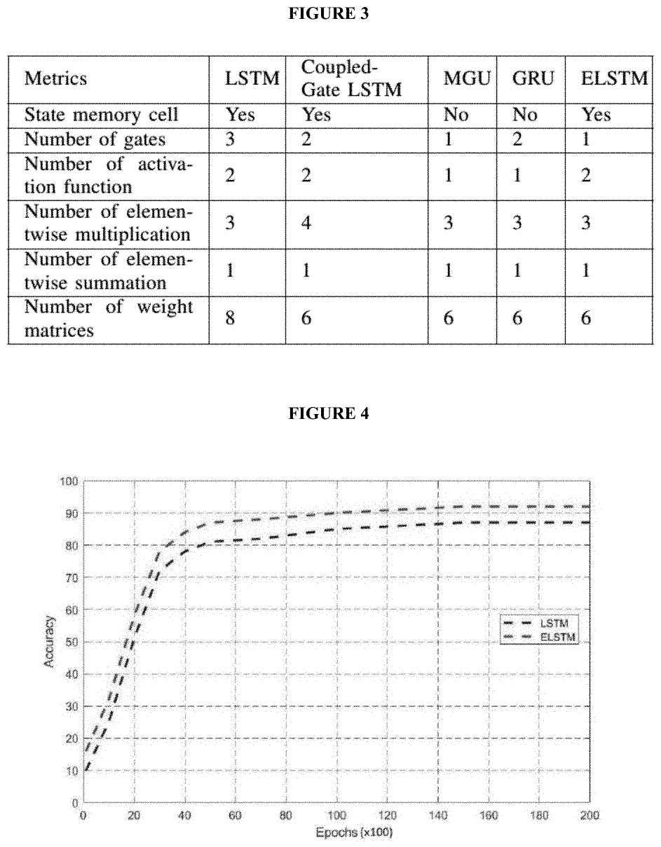

h(t)=f(t)⊙tanh(C(t))

Where C(t) is the final memory state, h(t) is the final output, and the ⊙ symbol represents elementwise multiplication. The comparison of computation components for LSTM, coupled gate LSTM, MGU, GRU, and ELSTM is shown in FIG. 3. This comparison shows the computation components of each structure in terms of the state memory cell, number of gates, number of activation function, number of elementwise multiplication, number of elementwise summation, and number of weight matrices. The ELSTM has a minimum number of gates (one gate) and two activation function that is lower than traditional LSTM and coupled-gate LSTM. The number of elementwise multiplication, number of elementwise summation, and number of weight matrices are comparable to other methods. The benefit of using fewer components in the ELSTM increases the computation speed. It also reduces the cost of designing in hardware level.

The ELSTM was implemented and tested using three data sets: MNIST, IMDB, and ImageNet datasets. The MNIST dataset contains handwritten digits images (0-9). It includes 10,000 images in the test set phase and 60,000 images in the training set phase. These images are preprocessed to make the center of these digits' mass to be at the central position of image size 28×28. MNIST has been commonly used for deep neural network classification. The testing is done using each row (28 pixels) as a single input. 100 hidden units with the batch size of 100 is used, and the learning rate is 10⁻¹⁰ with a momentum of 0.99. As shown in FIG. 4, the ELSTM's accuracy is higher than that of a traditional LSTM. ELSTM achieves an accuracy of 90.89% while the LSTM is 87.21% at the end of 20,000 epochs.

ELSTM was again tested by MNIST using another method that takes every pixel as one component in the input sequence. Therefore, an image spreads to become a sequence length of 784. The pixel scanning runs from left to right and top to bottom. The aim of this task is to test ELSTM performance in long sequence length. The simulation result shows ELSTM has an accuracy of 84.91% after 20,000 epochs and the traditional LSTM has an accuracy of 65% after 900,000 epochs.

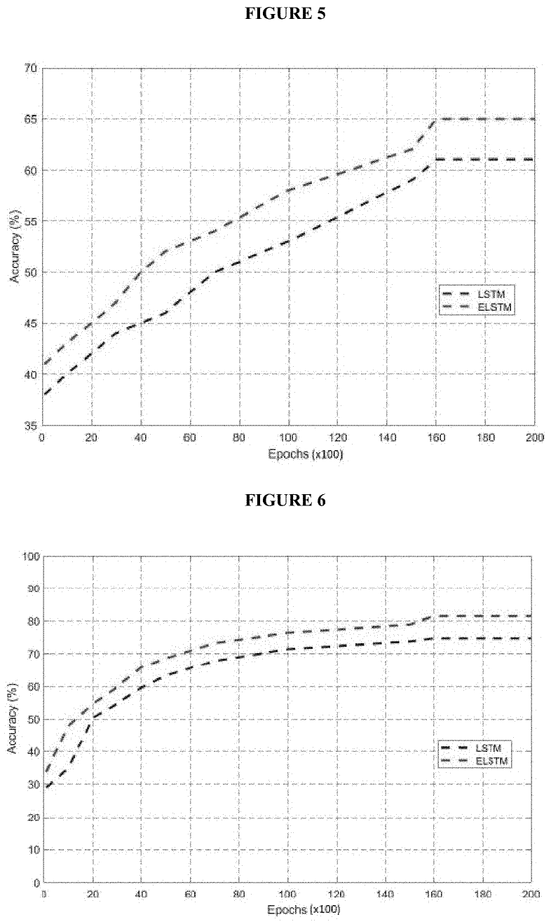

The second testing of the ELSTM was used to study the classification of sentiment in IMDB.com movie reviews. It separates the status of the reviews into a positive and negative review. The IMDB dataset contains 25,000 movie reviews for testing and another 25,000 for training. The sequence length has a maximum length of 128. The ELSTM is implemented using 100 hidden units with a batch size of 16, and 10⁻⁸ learning rate with 0.99 momenta. The simulation result shows the ELSTM has an accuracy of 65.03% while LSTM has an accuracy of 61.43% after 20,000 epochs, as seen in FIG. 5. Therefore, the ELST has a higher accuracy than LSTM, and the ELSTM is faster than LSTM due to the lower amount of computation components.

Third, ELSTM was tested using an ImageNet dataset. ImageNet includes 3.2 million cleanly labeled full resolution images with 12 subtrees with 5247 synonym set or synsets. The simulation result shows the ELSTM has 82.39% accuracy while LSTM has an accuracy of 75.12% after 20,000 epochs as seen in FIG. 6. This test shows that the ELSTM performs better than traditional LSTM.

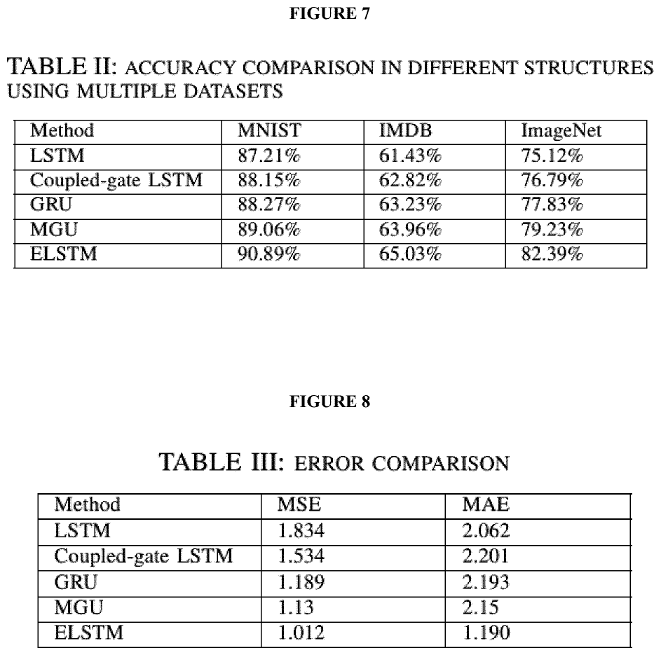

The simulation result of all tests using different datasets shows the disclosed ELSTM has better performance than LSTM. For deeper evaluation, the ELSTM was next compared to multiple LSTM structures such as coupled-gate LSTM, MGU, and GRU using the three data sets (MNIST, IMDB, and ImageNet) as shown in FIG. 7. This comparison shows the ELSTM has a comparable performance with known LSTM structures. Thus, the evaluation is presented using different structures and multiple datasets.

The error evaluation using Mean Squared (MSE) and Mean Absolute Error (MAE) is studied. The MSE measures the average of the squares of the errors, or is the average squared difference between the between the desired value and what is estimated. The MAE is a measure of the difference between two continuous variables. Each one is calculated using the following equations.

$$M S E = \frac{1}{n} {\sum }_{i = 1}^{n} {( {y}_{i} - \tilde{y} )}^{2}$$

$$M A E = \frac{{\sum }_{i = 1}^{n} \vert {y}_{i} - \tilde{y} \vert}{n}$$

Where yᵢ is the resulted value, \tilde{y} is the estimated value, and n is the number of results. The measurements of both MSE and MAE are shown in FIG. 8. These results are obtained using ImageNet dataset, the result shows the proposed method has a comparable error with the other models. The disclosed method provides comparable accuracy with LSTM because it has a few factors to tune and memory state has been used for forgetting and updating inputs, therefore, it will be easier to find the best performance for the disclosed method. ELSTM also has a low error due to these factors, and it has faster training which allows it to achieve higher accuracy faster.

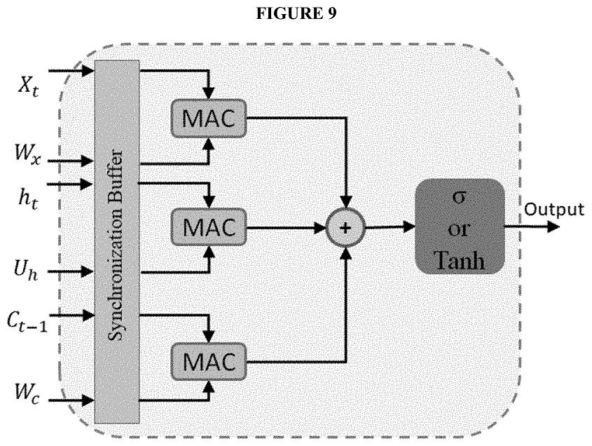

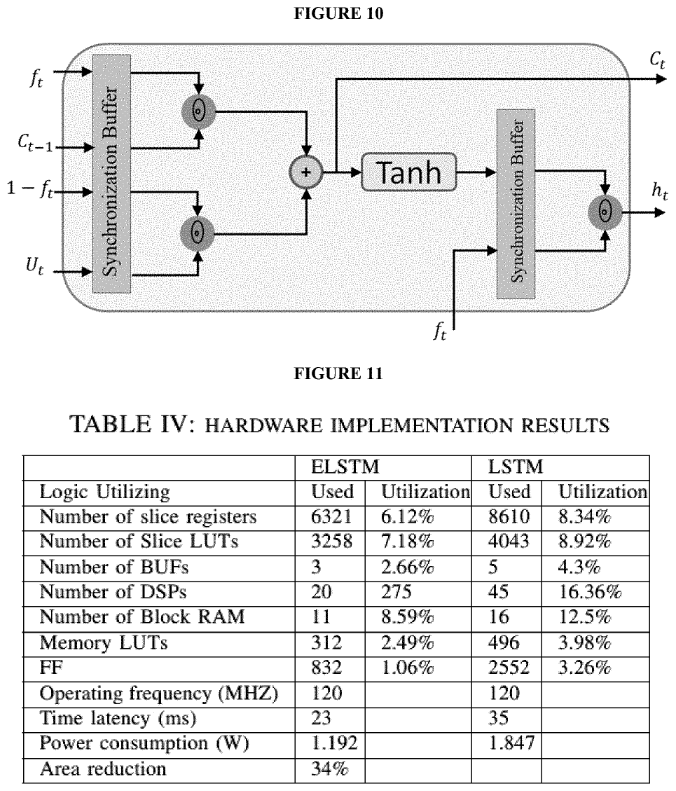

In hardware design, the hardware module of the gate is shown in FIG. 9. The input streams may not be synchronized even if the module triggers the ports at the same time. Consequently, a stream synchronization is required, the synchronization buffer is used to cache streaming data until all streaming ports are finished. The operation is needed to ensure that the matrices are aligned to feed Multiplier Accumulator (MAC) which performs multiplication and addition operations on the inputs. The final block can be for (σ) function or tanh function. The Module of obtaining Cₜ and hₜ from the results of the gates is presented in FIG. 10. Two synchronization buggers are used, with one being the input side and the second being the output side. The ELSTM architecture is implemented using three modules: two modules as shown in FIG. 9, wherein one module comprises a sigmoid block and the other comprises a tanh block, and one module as shown in FIG. 10. The disclosed method is testing and implemented using VHDL and Altera Arria 10 GX FPGA 10AX115N2F45E1SG. The operating frequency is 120 MHz. The simulation results of the hardware implementation are shown in FIG. 11 in terms of registers, LUTs, DSPs, Buffers, block RAM, Flip Flip (FF), etc. These results present the used resources that are consumed resources and utilization that is the ratio of used resources to the total available resources. The resources utilization for MGU in terms of registers, LTUs, Buffers, DSPs, block RAM, LUTs, and FFs are 8.37%, 8.96%, 4.5%, 16.42%, 12.7%, 4% and 3.31%, respectively. Thus, the consumed resources for the proposed method are lower than the state-of-the-art, which represents the reduction of consumer hardware. The hardware result also shows that the proposed method has a lower area by 34% compared to the original LSTM. The disclosed method has a latency of 23 ms, which is lower than the latency (35 ms) or original LSTM. The ELSTM also has a throughput of 258.4 MOPS while the LSTM has a throughput of 173.5 MOPS. Furthermore, the power consumption of ELSTM is 1.192 W, and the LSTM has a 1.847 W power consumption. Thus, the disclosed method is attractive to the hardware level due to the lower hardware cost of designing the proposed method. In addition the disclosed method is faster than the traditional LSTM due to using fewer components compared to traditional LSTM.

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

Although the terms “step” and/or “block” or “module” etc. might be used herein to connote different components of methods or systems employed, the terms should not be interpreted as implying any particular order among or between various steps herein disclosed unless and except when the order of individual steps is explicitly described.

Furthermore, the described features, structures, or characteristics may be combined in any suitable manner in one or more embodiments. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment. Moreover, the terms “substantially” or “approximately” as used herein may be applied to modify any quantitative representation that could permissibly vary without resulting in a change to the basic function to which it is related.

We claim:

1. A long short term memory cell architecture of a convolutional neural network comprising:
one gate, comprising:
at least one output;
at least three inputs comprising:
an x(t) input;
an h(t−1) input; and
a c(t−1) input;
a memory layer;
an update layer;
an output layer;
two activation functions;
one or more elementwise multiplication operations;
one or more elementwise summation operations; and
one or more weight matrices operations;
wherein the input of one activation function comprises:
the x(t) input;
the h(t−1) input; and
a c(t−1) input.

2. The architecture of claim 1, wherein the gate further comprises computer code capable of updating the data stored within the memory layer.

3. A method for deleting memory within a long short term memory cell of a convolutional neural network comprising:
providing a long short term memory comprising:
one gate, comprising:
at least one output;
at least three inputs comprising:
an x(t) input;
an h(t−1) input; and
a c(t−1) input;
one or more activation functions;
one or more elementwise multiplication operations;
one or more elementwise summation operations; and
one or more weight matrices operations;
providing data by the output of the gate to a memory layer;
the memory layer receiving a value fₜ from the output of the gate; and
performing the forget step by multiplying fₜ with a memory state.

4. The method of claim 3, wherein the forget step comprises:
generating a forget gate;
performing an elementwise product of (1−fₜ) and an output of an activation function;
wherein the activation function further comprises inputs:
the x(t) input;
the h(t−1) input; and
the c(t−1) input.

5. The method of claim 3, wherein the forget step comprises:
generating a forget gate;
performing an elementwise product of (1−fₜ) and an output of a tanh function;
wherein a tanh function further comprises inputs:
the x(t) input;
the h(t−1) input; and
the c(t−1) input;

6. The method of claim 3, wherein the output of the gate further provides data to an update layer.

7. The method of claim 3, wherein the output of the gate further provides data to an output layer.

8. A method for deleting memory within a long short term memory cell of a convolutional neural network comprising:
providing a long short term memory comprising:
at least four inputs, comprising:
a general input;
an input vector;
an output of the block at a time (t−1);
a stack comprising an internal state at the time (t−1);
a forget gate activation vector;
at least three convolutional weights;
one gate, comprising:
at least one output;
at least three inputs comprising:
an x(t) input;
an h(t−1) input; and
a c(t−1) input; and
two activation functions;
the output of the gate provides data to a memory layer;
the memory layer receives a value fₜ from the output of the gate; and
performing the forget step by multiplying fₜ with a memory state.

9. The method of claim 8, wherein the forget gate activation vector comprises f (t)ϵR^{d×h×n}, wherein d comprised the vector width, h comprised the vector height, and n comprised a total number of channels of fₜ.

10. The method of claim 8, wherein the input vector comprises x(t)ϵR^{d×h×r}, wherein r comprises a total number of input channels.

11. The method of claim 8, wherein the input vector comprises one or more images.

12. The method of claim 8, wherein the forget step comprises:
generating a forget gate;
performing an elementwise product of (1−fₜ) and an output of an activation function;
wherein the activation function further comprises inputs:
the x(t) input;
the h(t−1) input; and
the c(t−1) input.

13. The method of claim 8, wherein the output of the gate can be represented by an equation comprising f(t)=σ(W_{f}·I_{f}+b_{f});
wherein I_{f} represents the general input;
wherein W_{f} represents a convolutional weight; and
wherein b_{f} comprises a bias with a dimension of n×1.

14. The method of claim 8, wherein the output of the gate can be represented by an equation comprising f(t)=σ([W_{cf}, W_{xf}, U_{hf}]·[x(t), c(t−1), h(t−1)]+b_{f});
wherein f(t) represents the forget gate activation vector;
wherein W_{xf}, W_{cf}, and U_{hf} represent the convolutional weights;
wherein h(t−1) represents the output of the block or cell at the time of (t−1);
wherein c(t−1) represents the internal state of the stack at (t−1); and
wherein b_{f} comprises a bias with a dimension of n×1.

15. The method of claim 8, wherein the output of the gate can be represented by an equation comprising f(t)=σ([W_{cf}, W_{xf}, U_{hf}]·[x(t), c(t−1), h(t−1)]+b_{f});
wherein W_{xf}, W_{cf}, and U_{hf} represent the convolutional weights, each comprising a dimension (m×m) for all the kernels;
wherein h(t−1) represents the output of the block or cell at the time of (t−1);
wherein c(t−1) represents the internal state of the stack at (t−1); and
wherein b_{f} comprises a bias with a dimension of n×1.

16. A method for updating memory within a long short term memory cell of a convolutional neural network comprising:
providing a long short term memory comprising:
at least four inputs, comprising:
a general input;
an input vector;
an output of the block at a time (t−1);
a stack comprising an internal state at the time (t−1);
a forget gate activation vector;
at least three convolutional weights;
one gate, comprising:
at least one output;
at least three inputs comprising:
an x(t) input;
an h(t−1) input; and
a c(t−1) input; and
at least two activation functions;
the output of the gate provides data to a memory layer;
the memory layer receives a value fₜ from the output of the gate;
performing the forget step by multiplying fₜ with a memory state;
generating an output U(t) from one said activation function;
multiplying U(t) by (1−fₜ) to generate a result; and
adding the result to the memory state.

17. The method of claim 16, wherein the method for updating the memory state can be represented by an equation comprising C(t)=f(t)⊙C(t−1)+(1−f(t))⊙U(t);
wherein C(t) represents the updated memory state;
wherein f(t) represents the forget gate activation vector;
wherein c(t−1) represents the internal state of the stack at (t−1); and
wherein ⊙ represents performing elementwise multiplication.

18. The method of claim 16, wherein the output of the updated memory state can be represented by an equation comprising h(t)=f(t)⊙tanh(C(t));
wherein C(t) represents the updated memory state;
wherein f(t) represents the forget gate activation vector; and
wherein ⊙ represents performing elementwise multiplication.
